(19) United States
(12) Patent Application Publication
(10) Pub. No.: US 2023/0169025 A1
(43) Pub. Date: Jun. 1, 2023

(54) Direct memory access circuit, operation method thereof, and method of generating memory access command

(71) Applicant: SigmaStar Technology Ltd., Xiamen (CN)

(72) Inventor: Ya-Ming Deng, Shanghai (CN)

(21) Appl. No.: 17/899,052

(22) Filed: Aug. 30, 2022

(30) Foreign Application Priority Data
Nov. 26, 2021 (CN) 202111420496.4

(51) Int. Cl. G06F 13/28

(52) U.S. Cl. CPC G06F 13/28; G06F 2213/28

(57) ABSTRACT

A direct memory access (DMA) circuit, its operation method, and a method of generating memory access commands are provided. The DMA circuit is used to access a memory according to a command and includes a register, a first channel controller, and a second channel controller. The operation method of the DMA circuit includes the following steps: decoding the command to obtain a first channel code and a second channel code, the first channel code corresponding to the first channel controller, and the second channel code corresponding to the second channel controller; obtaining a state of the first channel controller from the register according to the first channel code; selecting the second channel controller according to the second channel code; and controlling the second channel controller according to the state.

This application claims the benefit of China application Serial No. CN202111420496.4, filed on Nov. 26, 2021, the subject matter of which is incorporated herein by reference.

### BACKGROUND OF THE INVENTION

### 1. Field of the Invention

The present invention generally relates to accesses to a memory, and, more particularly, to a direct memory access (DMA) circuit, a method of operating same, and a method of generating memory access commands

### 2. Description of Related Art

When the electronic device calculates equation (1) below, the detailed steps are: (i) calculating C11 (i.e., equation (1a)); (ii) saving the data C11 to a target location in the memory; (iii) reading the data C11 from the target location in the memory; and (iv) calculating E11 (i.e., equation (1b)).

E11=A11×B+D (1)

C11=A11×B (1a)

E11=C11+D (1b)

E12=A12×B+D (2)

When the conventional computer or electronic device calculates equation (1) and equation (2), they take the operator bulk synchronization approach to perform the calculation to ensure the correct result. The operator bulk synchronization approach is that the computer or electronic device first completes the calculation of equation (1) (i.e., the result E11 is first obtained) and then performs the calculation of equation (2). However, the completion of equation (1) is not a requirement to start the multiplication operation of equation (2) (i.e., “A12×B”). More specifically, since the reading of the data A12 does not affect the calculation of equation (1), preferably, the computer or electronic device can read the data A12 from the memory while performing the multiplication operation of equation (1) (i.e., “A11×B”) so that the calculation performance can be improved.

However, some data (e.g., the data C11 in equations (1a) and (1b)) cannot be accessed or modified at any wanted time (i.e., the data C11 must be stored before read out); otherwise, incorrect calculation results are likely to be generated. In other words, the memory space where the data is stored cannot be read or written to at any wanted time. Therefore, a method of generating memory access commands, a related DMA circuit, and a method of operating same are required to improve the performance of a computer or an electronic device.

### SUMMARY OF THE INVENTION

In view of the issues of the prior art, an object of the present invention is to provide a DMA circuit, a method of operating same, and a method of generating memory access commands, so as to make an improvement to the prior art.

According to one aspect of the present invention, a DMA circuit for accessing a memory according to a command is provided. The DMA circuit includes a first channel controller, a second channel controller, a decoder, a register, and a controller. The first and second channel controllers are configured to access the memory. The decoder is configured to decode the command to obtain a first channel code and a second channel code, the first channel code corresponding to the first channel controller, and the second channel code corresponding to the second channel controller. The register stores a state of the first channel controller. The controller is coupled to the decoder and the register and configured to execute the following steps: obtaining the state from the register according to the first channel code; selecting the second channel controller according to the second channel code; and controlling the second channel controller according to the state.

According to another aspect of the present invention, a method of operating a DMA circuit which is configured to access a memory according to a command and includes a register, a first channel controller, and a second channel controller is provided. The method includes the following steps: decoding the command to obtain a first channel code and a second channel code, wherein the first channel code corresponds to the first channel controller, and the second channel code corresponds to the second channel controller; obtaining a state of the first channel controller from the register according to the first channel code; selecting the second channel controller according to the second channel code; and controlling the second channel controller according to the state.

According to still another aspect of the present invention, a method of generating a memory access command is provided. A memory block is accessed by a first command and a second command that are consecutive, and the second command immediately follows the first command. The method includes the following step: using an own channel code of the first command as a parameter of the second command when one of the first command and the second command is a read command and another is a write command. The own channel code corresponds to a channel controller of a DMA circuit, and the channel controller is configured to execute the first command

The present invention controls the access to memory according to the dependency between consecutive memory access commands In comparison with the prior art, the electronic device or chip using the DMA circuit of the present invention can improve the calculation performance by performing calculations in a more efficient manner

These and other objectives of the present invention no doubt become obvious to those of ordinary skill in the art after reading the following detailed description of the preferred embodiments with reference to the various figures and drawings.

### BRIEF DESCRIPTION OF THE DRAWINGS

FIG. 1 is a flowchart of a method of generating memory access commands according to an embodiment of the present invention.

FIG. 2 shows the command format according to an embodiment of the present invention.

FIG. 3 shows the command format according to another embodiment of the present invention.

FIG. 4 is a functional block diagram of a DMA circuit according to an embodiment of the present invention.

FIG. 5 shows an example of the state table of the channel controller.

FIG. 6 is a flowchart of a method of operating a DMA circuit according to an embodiment.

FIG. 7 shows a flowchart of step S670 according to an embodiment.

FIG. 8 shows a functional block diagram of the channel controller according to an embodiment of the present invention.

### DETAILED DESCRIPTION OF THE EMBODIMENTS

The following description is written by referring to terms of this technical field. If any term is defined in this specification, such term should be interpreted accordingly. In addition, the connection between objects or events in the below-described embodiments can be direct or indirect provided that these embodiments are practicable under such connection. Said “indirect” means that an intermediate object or a physical space exists between the objects, or an intermediate event or a time interval exists between the events.

The disclosure herein includes a DMA circuit, an operation method thereof, and a method of generating memory access commands On account of that some or all elements of the DMA circuit could be known, the detail of such elements is omitted provided that such detail has little to do with the features of this disclosure, and that this omission nowhere dissatisfies the specification and enablement requirements. A person having ordinary skill in the art can choose components or steps equivalent to those described in this specification to carry out the present invention, which means that the scope of this invention is not limited to the embodiments in the specification.

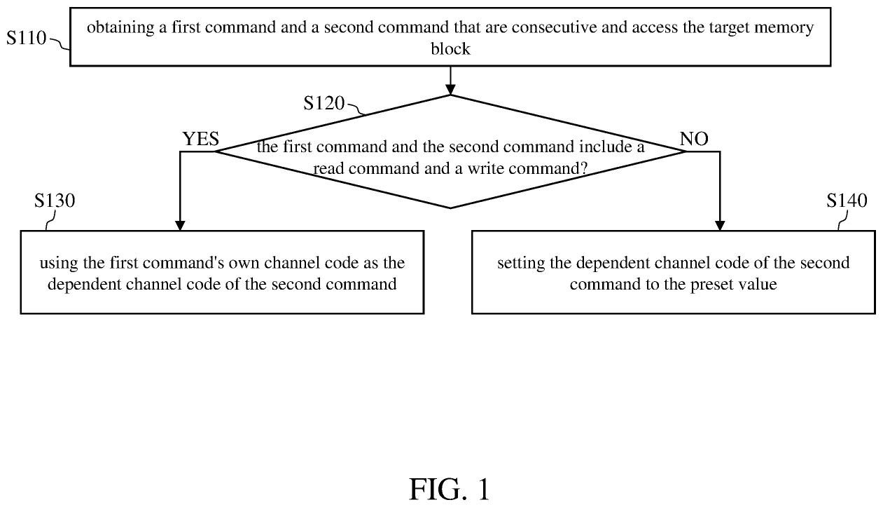

In the course of developing a product, for hardware such as a computing model (e.g., a neural network model), intelligent processing unit (IPU), or DMA, product development tools (e.g., computers) first analyze the dependencies among the data and then generate memory access commands based on the dependencies among the data. The product is, for example, an electronic device, a chip, or other hardware with computing capabilities, and the product uses a DMA circuit to control the access (read or write) to a memory (including but not limited to cache or random access memory (RAM)). More specifically, the data to be calculated by the computing model is divided into a plurality of data pages by software (the size of each data page is, for example, 4 KB), a memory (cache or RAM) is correspondingly divided into multiple memory blocks (the size of each memory block corresponds to the size of the data page), and the dependencies among data are traced for each data page by the product development tools. In one embodiment, each data page is written into or read from a certain memory block through a corresponding access command, and the product development tool can trace the dependencies among the data of a data page by analyzing multiple access commands of a certain memory block (hereinafter, referred to as a target memory block that is configured to store a target data page). The product development tool analyzes two consecutive commands (e.g., a first command and a second command which immediately follows the first command, that is, the first command being the previous command of the second command), which perform operations on the target memory block, to determine whether to add data dependency information (or data synchronization information), based on which the product development tool generates a memory access command that accesses the target data page. FIG. 1 shows the detailed process which includes the following steps.

Step S110: obtaining the first and second commands that are consecutive and access the target memory block (i.e., the first and second commands read the target data page from the target memory block, write the target data page to the target memory block, or update the target data page in the target memory block (which is equivalent to the write operation)). Specifically, for an operation that accesses a target data page (which operation is of a certain operation of the product), the product development tool can obtain the consecutive first and second commands, where the operation first uses the first command to access the target memory block and then uses the second command to access the target memory block, and between the first command and the second command there is not any command that accesses the target memory block.

It should be noted that a command (i.e., the above-mentioned first command or second command) contains or carries its own channel code which corresponds to a channel controller of a DMA circuit. In other words, when executing a read (or write) command, the DMA circuit designates, with the read (or write) command's own channel code, a channel controller to perform the read (or write) operation.

Step S120: The product development tool determines whether the first command and the second command include a read command and a write command If YES (i.e., one of the first command and the second command is a read command and the other is a write command), it is deemed that there is a data dependency between the first command and the second command, and the product development tool performs step S130; if NO (i.e., both the first command and the second command are read commands or write commands), the product development tool performs step S140.

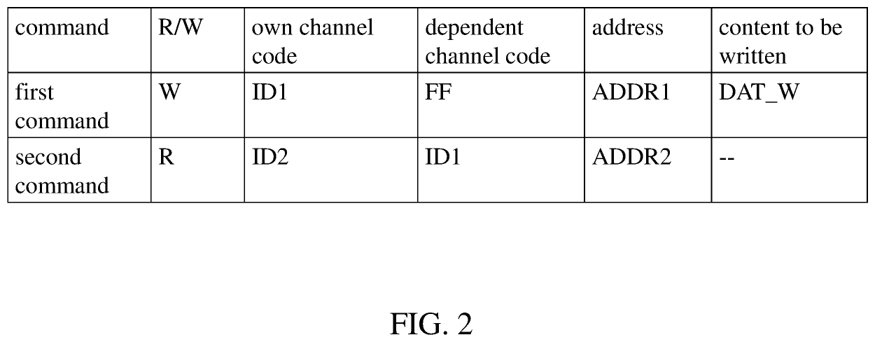

Step S130: The product development tool uses the first command's own channel code as a parameter of the second command (i.e., the dependent channel code discussed below), and this parameter is the data dependency information. Reference is made to FIG. 2, which shows the command format according to an embodiment of the present invention. The format of FIG. 2 is intended to illustrate the invention by way of examples, rather than to limit the scope of the claimed invention. In the example of FIG. 2, a command may contain five parameters: “read/write” (R/W), “own channel code,” “dependent channel code,” “address,” and “content to be written;” the first command is a write (indicated by “W”) command, the second command is a read (indicated by “R”) command, and the dependent channel code “FF” of the first command is a preset value, which in other embodiments can be “0” or other values. As shown in FIG. 2, the “own channel code” parameter of the first command and the “dependent channel code” parameter of the second command are both “ID1,” indicating that the second command is dependent on the first command The preset value “FF” means that the first command is not dependent on its previous command

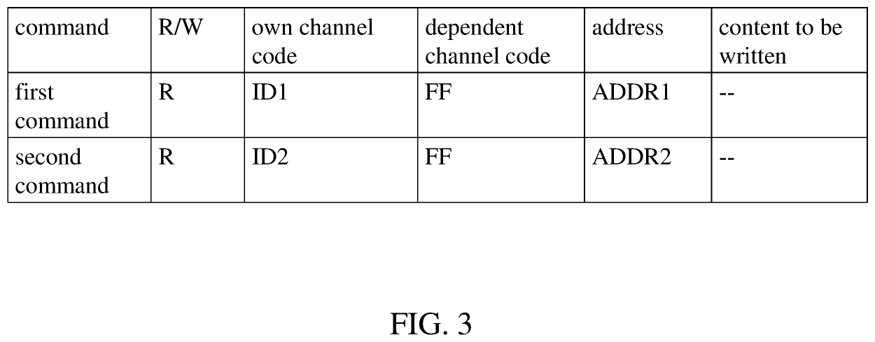

Step S140: The product development tool sets the dependent channel code of the second command to the preset value. Reference is made to FIG. 3, which shows the command format according to another embodiment of the present invention. The format of FIG. 3 is intended to illustrate the invention by way of examples, rather than to limit the scope of the claimed invention. Since the first command and the second command are both read commands in the example of FIG. 3, the product development tool sets the dependent channel code of the second command to the preset value “FF,” which indicates that the second command does not depend on the first command Note that when the first command and the second command are both write commands, the dependent channel code of the second command is also the preset value “FF.”

Repeating the flow of FIG. 1, the product development tool scans the access commands of the operation in terms of each data page to determine whether each command is dependent on its previous command In some embodiments, the process of FIG. 1 is embodied by software; in other words, the product development tool completes the process of FIG. 1 by executing program codes or program instructions.

What follows is the discussion of how the DMA circuit operates according to the “own channel code” and the “dependent channel code.”

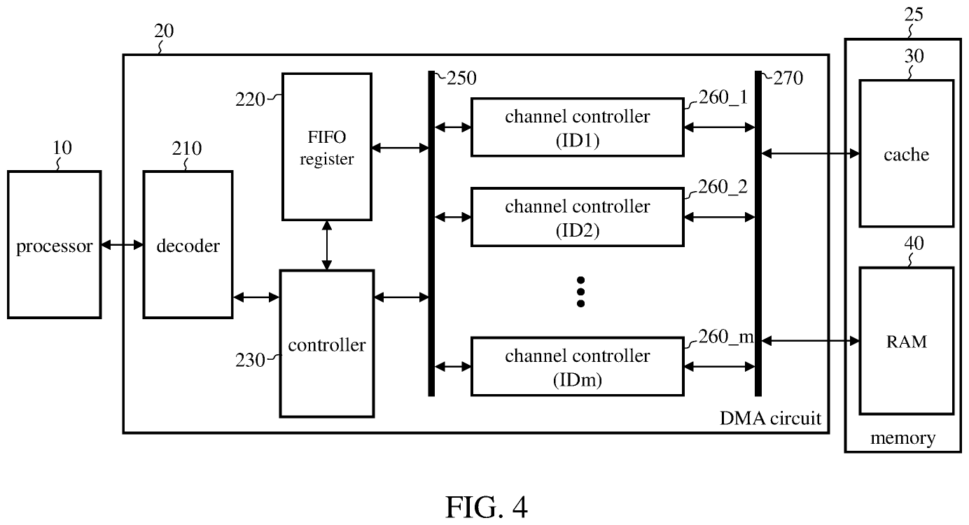

FIG. 4 is a functional block diagram of the DMA circuit according to an embodiment of the present invention. The components of FIG. 4, which are part of the aforementioned product, include a processor 10, a DMA circuit 20, and a memory 25 (including but not limited to a cache 30 and a RAM 40). The processor 10 accesses the cache 30 and the RAM 40 through the DMA circuit 20. The DMA circuit 20 includes a decoder 210, a first-in-first-out (FIFO) register 220, a controller 230, a bus 250, m channel controllers 260 (260_1, 260_2, . . . , 260_m, where m is an integer greater than 1), and a bus 270. The channel codes of them channel controllers 260 are ID1, ID2, . . . , and IDm, respectively.

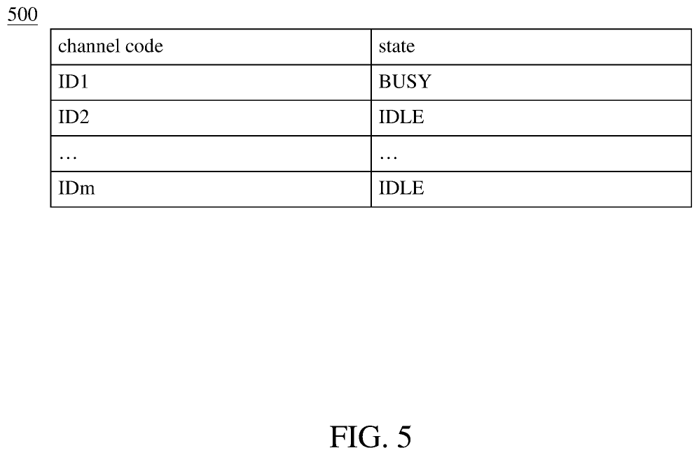

When the processor 10 is performing to write/read a target data page into/from the memory 25, the processor 10 sends a target command to the DMA circuit 20. The decoder 210 obtains all parameters of the target command issued by the processor 10 by decoding the target command and then sends the parameters to the controller 230. The FIFO register 220 stores the states of the m channel controllers 260. The controller 230, which is coupled to the decoder 210 and the FIFO register 220, is used for controlling, according to the target command's own channel code, the corresponding channel controller 260 to perform the task of the target command In addition to accessing the cache 30 or the RAM 40, the channel controller 260 also updates its own state in the FIFO register 220. Reference is made to FIG. 5 which is an example of the state table 500 of the channel controller 260. The state table 500 is stored in the FIFO register 220. “BUSY” indicates that the channel controller is in a busy state (e.g., it is accessing the cache 30 or RAM 40), and “IDLE” indicates that the channel controller is in an idle state.

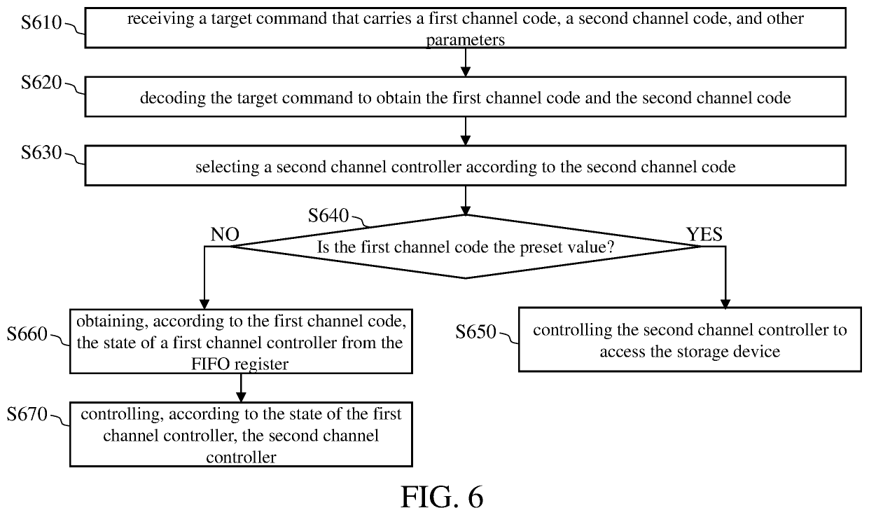

FIG. 6 is a flowchart of a method of operating a DMA circuit according to an embodiment. The operation of the DMA circuit 20 is discussed below in connection with FIG. 6.

Step S610: The DMA circuit 20 receives from the processor 10 a target command that carries a first channel code (i.e., the dependent channel code) and a second channel code (i.e., the own channel code). For example, if the target command is the second command of FIG. 2, the first channel code is “ID1,” and the second channel code is “ID2.”

Step S620: The decoder 210 decodes the target command to obtain the first channel code, the second channel code, and other parameters of the target command. The target command has been encoded by the processor 10 conforming to a certain encoding scheme, and the decoder 210 decodes the target command conforming to a decoding scheme corresponding to the encoding scheme. The decoding operation is well known to people having ordinary skill in the art, and the details are omitted for brevity.

Step S630: The controller 230 selects a second channel controller according to the second channel code. Continuing the above example where the target command is the second command of FIG. 2, the controller 230 selects the second channel controller 260_2 corresponding to the second channel code “ID2.”

Step S640: The controller 230 determines whether the first channel code is the preset value. If the first channel code is the preset value (meaning that the target command does not depend on its previous command, that is, the target command and its previous command are of the same type (i.e., both read operations or write operations)), then the controller 230 performs step S650. If the first channel code is not the preset value (meaning that the target command depends on its previous command, that is, the target command and its previous command are not of the same type (i.e., one of which is a read operation, while the other a write operation)), then the controller 230 performs steps S660 and S670. Here, the target command and its previous command are consecutive commands that perform operations on the target memory block; that is, for the target memory block, the target command immediately follows the previous command. However, for the processor 10 and the controller 230, there may be intervening command(s) between the target command and its previous command, but the intervening command(s) does(do) not access the target memory block.

Step S650: The controller 230 controls the second channel controller 260_2 to access the memory 25, that is, the channel controller 260_2 performs the task of the target command

Step S660: The controller 230 obtains, according to the first channel code, the state of a first channel controller from the FIFO register 220. Continuing the above example where the target command is the second command of FIG. 2 and the states of the channel controllers 260 are shown as the state table of FIG. 5, the controller 230 uses the first channel code “ID1” as an index to look up in the state table 500 and learn that the state of the first channel controller 260_1 corresponding to “ID1” is busy.

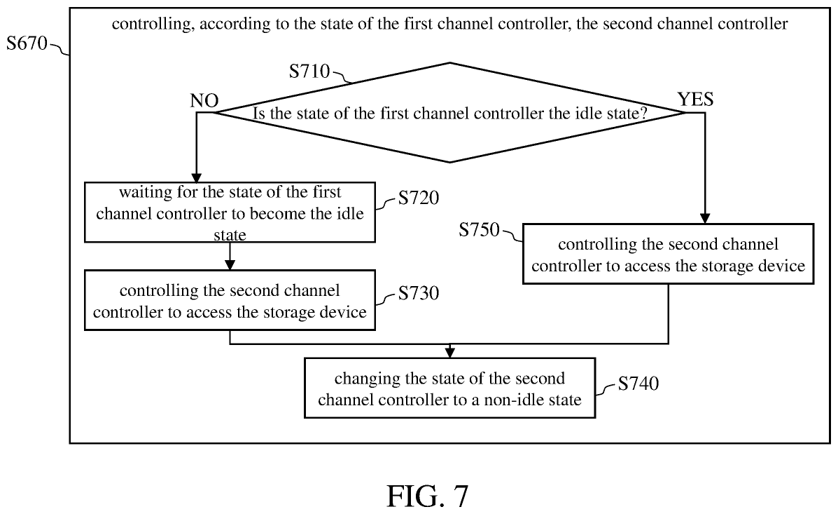

Step S670: The controller 230 controls, according to the state of the first channel controller 260_1, the second channel controller 260_2. The details of step S670 are discussed below in connection with FIG. 7.

Reference is made to FIG. 7 which shows a flowchart of step S670 according to an embodiment. The flowchart includes the following steps.

Step S710: The controller 230 determines whether the state of the first channel controller 260_1 is the idle state. If NO, step S720, step S730, and step S740 are performed; if YES, step S750 and step S740 are performed.

Step S720: The controller 230 waits for the state of the first channel controller 260_1 to become the idle state. After finishing a task (e.g., finishing a read operation or a write operation), the channel controller 260 changes its own state in the state table 500 to “IDLE.” On the contrary, after receiving a task, the channel controllers 260 changes its own state in the state table 500 to “BUSY.” In other words, in step S720, the controller 230 waits for the first channel controller 260_1 to finish the current task so that the correctness of the data can be ensured.

Step S730: After the state of the first channel controller 260_1 becomes the idle state, the controller 230 controls the second channel controller 260_2 to access the memory 25. Step S730 and step S650 are identical.

Step S740: After receiving the task, the second channel controller 260_2 changes its own state in the state table 500 to a non-idle state (i.e., the “BUSY” state).

Step S750: The controller 230 controls the second channel controller 260_2 to access the memory 25. Step S750, step S730, and step S650 are identical.

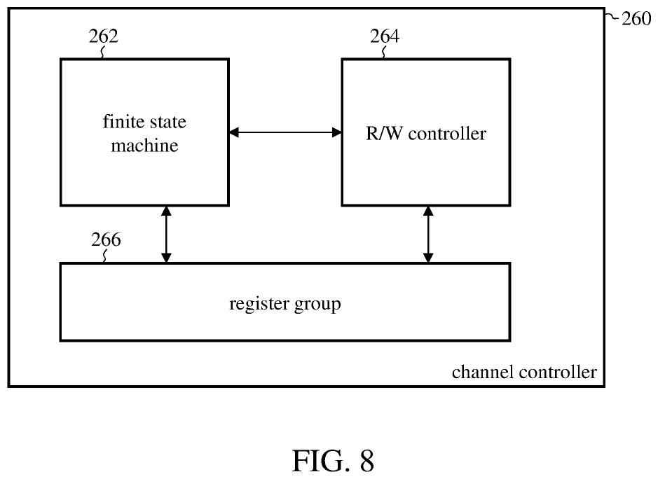

FIG. 8 shows a functional block diagram of the channel controller 260 according to an embodiment of the present invention. The channel controller 260 includes a finite state machine 262, a R/W controller 264, and a register group 266. The register group 266 stores the system parameters (including but not limited to the information of the bus 250 and the bus 270, the width of each read/write data, the parameters of the DMA circuit 20, the parameters of the RAM 40, etc.). The finite state machine 262 controls the R/W controller 264 to perform read operations and write operations according to the system parameters stored in the register group 266 and various parameters of the target command. In addition, the finite state machine 262 also switches the state (idle or busy) according to whether the channel controller 260 is performing a task and updates the corresponding field in the state table 500 stored in the FIFO register 220.

People having ordinary skill in the art can design the controller 230 based on the above discussions. In some embodiments, the controller 230 may be embodied by circuits (such as a programmable logic device (PLD)) or hardware; in other embodiments, the controller 230 may perform the above operations by executing program codes or program instructions.

To sum up, according to the present invention, the DMA circuit 20 and the method of operating same trace the dependencies between the consecutive commands of each data page and control the channel controller according to the dependencies. As a result, it can be ensured that both a read operation that immediately follows a write operation and a write operation that immediately follows a read operation do not cause data errors. Therefore, an electronic device or chip using the DMA circuit 20 can perform calculations in a more efficient manner. Taking the aforementioned equation (1) and equation (2) as an example, by determining the dependency of the data C11 in equation (1a) and equation (1b) (i.e., by assigning the dependent channel code), the present invention can ensure that the correct data C11 is obtained when equation (1b) is being calculated; in this way, compared with the operator bulk synchronization approach of the prior art, the present invention can calculate equation (2) in advance. In other words, the present invention can improve the operation performance by arranging the operations of data with finer granularity.

The aforementioned descriptions represent merely the preferred embodiments of the present invention, without any intention to limit the scope of the present invention thereto. Various equivalent changes, alterations, or modifications based on the claims of the present invention are all consequently viewed as being embraced by the scope of the present invention.

What is claimed is:

1. A DMA circuit for accessing a memory according to a command, comprising:
a first channel controller for accessing the memory;
a second channel controller for accessing the memory;
a decoder for decoding the command to obtain a first channel code and a second channel code, the first channel code corresponding to the first channel controller, and the second channel code corresponding to the second channel controller;
a register for storing a state of the first channel controller; and
a controller coupled to the decoder and the register and configured to execute following steps:
obtaining the state from the register according to the first channel code;
selecting the second channel controller according to the second channel code; and
controlling the second channel controller according to the state.

2. The DMA circuit of claim 1, wherein the step of controlling the second channel controller according to the state comprises:
waiting for the first channel controller to be in an idle state and then controlling the second channel controller to access the memory when the state indicates that the first channel controller is not in the idle state.

3. The DMA circuit of claim 2, wherein the state is a first state, the register further stores a second state of the second channel controller, and the second channel controller changes the second state to a non-idle state when the second channel controller starts to access the memory.

4. The DMA circuit of claim 1, wherein the step of controlling the second channel controller according to the state comprises:
the controller controlling the second channel controller to access the memory when the state indicates that the first channel controller is in an idle state.

5. The DMA circuit of claim 4, wherein the state is a first state, the register further stores a second state of the second channel controller, and the second channel controller changes the second state to a non-idle state when the second channel controller starts to access the memory.

6. The DMA circuit of claim 1, wherein the DMA circuit receives a previous command before receiving the command, the previous command controls the first channel controller to perform a read operation on a memory block of the memory, and the command controls the second channel controller to perform a write operation on the memory block of the memory.

7. A method of operating a direct memory access (DMA) circuit which is configured to access a memory according to a command and comprises a register, a first channel controller, and a second channel controller, the method comprising:
decoding the command to obtain a first channel code and a second channel code, wherein the first channel code corresponds to the first channel controller, and the second channel code corresponds to the second channel controller;
obtaining a state of the first channel controller from the register according to the first channel code;
selecting the second channel controller according to the second channel code; and
controlling the second channel controller according to the state.

8. The method of claim 7, wherein the step of controlling the second channel controller according to the state comprises:
waiting for the first channel controller to be in an idle state and then controlling the second channel controller to access the memory when the state indicates that the first channel controller is not in the idle state.

9. The method of claim 8, wherein the state is a first state, and the register further stores a second state of the second channel controller, the method further comprising:
changing the second state to a non-idle state when the second channel controller starts to access the memory.

10. The method of claim 7, wherein the step of controlling the second channel controller according to the state comprises:
controlling the second channel controller to access the memory when the state indicates that the first channel controller is in an idle state.

11. The method of claim 7, wherein the DMA circuit receives a previous command before receiving the command, the previous command controls the first channel controller to perform a read operation on a memory block of the memory, and the command controls the second channel controller to perform a write operation on the memory block of the memory.

12. A method of generating a memory access command, wherein a memory block is accessed by a first command and a second command that are consecutive, and the second command immediately follows the first command, the method comprising
using an own channel code of the first command as a parameter of the second command when one of the first command and the second command is a read command and another is a write command;
wherein the own channel code corresponds to a channel controller of a direct memory access (DMA) circuit, and the channel controller is configured to execute the first command.

13. The method of claim 12 further comprising:
setting the parameter of the second command to a preset value when both the first command and the second command are the read command or the write command.
